(19) United States
(12) Patent Application Publication
(10) Pub. No.: US 2026/0358490 A1
(43) Pub. Date: Nov. 12, 2026

(54) METHOD FOR RADAR ANGLE ESTIMATION

(71) Applicant: Robert Bosch GmbH, Stuttgart (DE)

(72) Inventors: Arthur Hipke, Leonberg (DE); Benedikt Loesch, Stuttgart (DE); Lizhuo Chen, Ludwigsburg (DE)

(21) Appl. No.: 19/129,699

(22) PCT Filed: Jan. 16, 2024
(86) PCT No.: PCT/EP2024/050853

§ 371 Date: May 14, 2025

(30) Foreign Application Priority Data
Feb. 22, 2023 (DE) 10 2023 201 585.4

(51) Int. Cl. G01S 13/42; G01S 7/41

(52) U.S. Cl. CPC G01S 13/42; G01S 7/418

(57) ABSTRACT

A method for angle estimation using signals from an in at least one dimension angle-resolving and MIMO-capable antenna array-comprising radar sensor that are transmitted and received after being reflected on an object. A cross-path model which also models reflections of transmitted and/or received signals from a reflecting surface is used to estimate the location angle of a radar target. The angle estimation is based on a reduced cross-path model that combines a model for a SIMO mode of the radar sensor with a model for a MISO mode.

### FIELD

The present invention relates to a method for angle estimation using signals from an in at least one dimension angle-resolving and MIMO-capable antenna array-comprising radar sensor that are transmitted and received after being reflected on an object, wherein a cross-path model which also models reflections of transmitted and/or received signals from a reflecting surface is used to estimate the location angle of a radar target.

In particular, the present invention relates to methods for radar sensors used in driver assistance systems of motor vehicles for sensing the surroundings.

### BACKGROUND INFORMATION

In addition to the distance and the relative velocity of the located objects, the azimuth angle and the elevation angle are also important in driver assistance systems, because this angle information can be used to assign a lane and make a statement about the relevance of the target (can be driven over/can be driven against/can be driven under). The azimuth and elevation angles of the targets can be ascertained from amplitude and/or phase differences between the transmitting and/or receiving antennas of an antenna array. The MIMO principle (multiple input multiple output) is often used for radar sensors to improve the accuracy and separability of the angle estimation. Unlike traditional SIMO (single input multiple output) radars, which use only one transmitting antenna and multiple receiving antennas, this method uses multiple transmitting antennas and multiple receiving antennas. During angle estimation, the received signals are compared with a previously measured angle-dependent antenna radiation pattern. If there is only one target in a (d,v) cell (distance/velocity cell), the resulting estimated angle is the position of the best match between the receive signal and the antenna radiation pattern.

M. Wintermantel: “Radar system comprising overlapping transmitter and receiver antennas,” U.S. Pat. No. 8,436,763 B2 describe a MIMO radar sensor that uses the MIMO principle with code-division multiplexing and two transmitting antennas to improve the azimuth angle estimation. The two transmitting antennas are disposed on the left or right edge of the overall array in order to achieve as large a virtual aperture as possible. In the case of multipath propagation due to reflections, for example on a guard rail or the road surface, four different paths of signal propagation occur, namely a path on which the signal propagates directly from the radar sensor to the object and back to the radar sensor without reflection, a path in which the signal propagates directly from the radar sensor to the object but is reflected on the return path to the radar sensor, a path in which the signal is reflected on the way to the object and travels without reflection directly to the radar sensor on the return path, and lastly a path in which the signal is reflected on the way to the object and the radar echo is reflected again on the same surface on the return path. Signal models that represent this scenario are referred to as cross-path models.

If multipath propagation is ignored in the signal model, a MIMO angle estimation will produce incorrect estimated values with errors of multiple angular degrees. This can then lead to undesirable system behavior, such as adjacent lane interference or target object loss.

Multipath propagation also means that the virtual array model cannot be used in MIMO beamforming (beamforming of both the transmission and the reception beam). In F. Engels, P. Heidenreich, M. Wintermantel, L. Stacker, M. Al Kadi and A. M. Zoubir, “Automotive Radar Signal Processing: Research Directions and Practical Challenges,” in IEEE Journal of Selected Topics in Signal Processing, doi: 10.1109/JSTSP.2021.3063666, beamforming with separate grids for the transmission angle (direction-of-departure (DOD)) and the reception angle (direction-of-arrival (DOA)) is presented as a remedial measure.

A method for a MIMO radar sensor that uses the entire multipath signal model has been proposed as well. This allows robust angle estimation, but it requires considerable computational effort and thus a high computing capacity.

### SUMMARY

An object of the present invention is to provide a method which, in the case of multipath propagation, enables accurate and reliable angle estimation with reduced computational effort.

This object may be achieved according to the present invention in that the angle estimation is carried out based on a reduced cross-path model that combines a model for a SIMO mode of the radar sensor with a model for a MISO mode.

In SIMO (single input multiple output) mode, a signal is transmitted by a single transmitting antenna and the signal received by multiple receiving antennas is evaluated in multiple receiving channels in order to calculate an angular spectrum in at least one dimension based on the phase and amplitude relationships using a cross-path model. In MISO (multiple input single output) mode, on the other hand, signals are transmitted in time-, frequency-, or code-division multiplexing by multiple transmitting antennas, and only the signals in a single receiving channel are evaluated for the evaluation of the associated radar echoes. In this way, another angular spectrum is obtained, again using a cross-path model, the information content of which differs from the angular spectrum obtained in SIMO mode. The information available in the two spectra is then combined. Thus a similarly precise and reliable angle estimation is achieved as with the MIMO method, but, due to the restriction to a single transmitting antenna in SIMO mode and the restriction to a single receiving antenna in MISO mode, the computational effort in this method is significantly reduced.

Advantageous embodiments and further developments of the present invention are disclosed herein.

As part of a maximum likelihood angle estimation (in azimuth and/or elevation), the angular spectra obtained in SIMO mode and in MISO mode can be non-coherently added to form a one-dimensional or two-dimensional sum spectrum.

An embodiment example of the present invention is explained in more detail in the following with reference to the figures.

### BRIEF DESCRIPTION OF THE DRAWINGS

FIG. 1 shows a schematic illustration of the analog portion of a radar system.

FIG. 2 shows a diagram of an antenna array of the radar system.

FIG. 3 shows a diagram illustrating a scenario with multipath propagation.

FIG. 4 shows a block diagram of the method according to an example embodiment of the present invention.

FIG. 5 shows an example of an angular spectrum obtained in SIMO mode.

FIG. 6 shows an angular spectrum obtained in MISO mode for the same surroundings configuration as in FIG. 5.

FIG. 7 shows a sum spectrum formed from the spectra of FIGS. 5 and 6.

FIG. 8 shows a reference spectrum that was calculated for the same surroundings constellation using a complete MIMO model.

### DETAILED DESCRIPTION OF EXAMPLE EMBODIMENTS

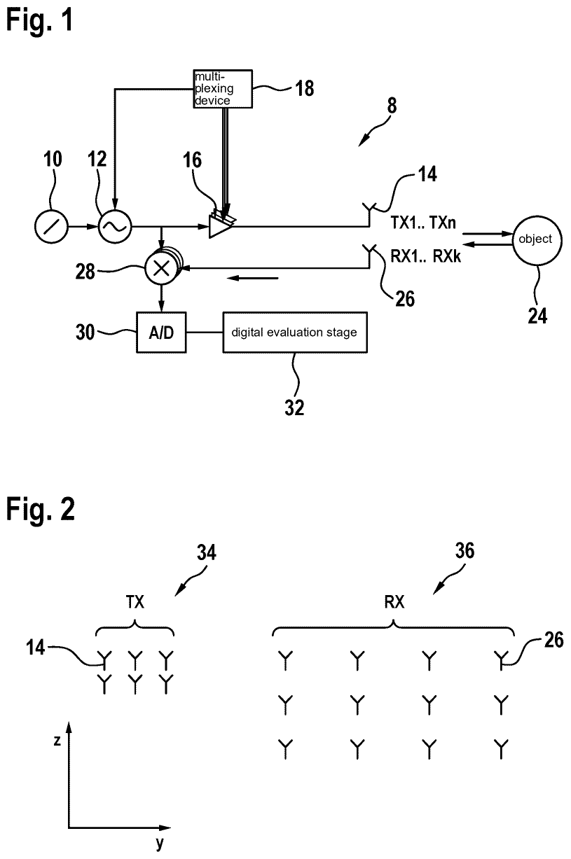

FIGS. 1 to 4 illustrate an embodiment example of a radar system with which the method according to the present invention is carried out.

FIG. 1 shows a schematic and simplified structure of the analog portion of the radar system.

A frequency modulation device 10 controls an HF oscillator 12, which generates sequences of signals in the form of frequency ramps for multiple transmitting antennas 14. An amplifier 16, which either blocks the signals or forwards them, amplified, to the associated antenna, is disposed in each of the multiple transmission channels. The oscillator 12 and the amplifiers 16 are controlled by a multiplexing device 18, for example according to a time and frequency multiplexing scheme, such that each of the transmitting antennas 14 transmits a frequency-modulated signal in a specific frequency subband within specific time slots.

The transmitted signal reflected on an object 24 is received by multiple receiving antennas 26 and, in each receiving channel, is mixed by a mixer 28 with a portion of the signal of the HF oscillator 12 and brought into a low-frequency range. An A/D conversion is then carried out in the usual manner by an A/D converter 30. The digitized signals are then further processed in a digital evaluation stage 32.

As FIG. 2 shows, the transmitting antennas 14 form a transmitter array 34 and the receiving antennas 26 form a receiver array 36. Both arrays in the shown example are two-dimensional, so that MIMO angle measurements would in principle be possible in both azimuth and elevation.

In the receiver array 36, the receiving antennas 26 are spaced at equal intervals in an angular resolution direction y, e.g. in the direction of the azimuth. The distances between the individual receiving antennas are so large that a large aperture and a correspondingly high angular resolution can be achieved with just a few antennas. However, the distances from antenna to antenna are greater than half the wavelength of the radar radiation, so that the Nyquist criterion is not met.

In the example shown here, the receiving antennas 26 are also spaced at equal intervals in elevation (in the angular resolution direction z), and, in this direction too, the antenna spacing is so large that non-unambiguous undersampling takes place.

In this example, the transmitting antennas 14 of the transmitter array 42 are likewise spaced at equal intervals in azimuth and elevation, but the distances are selected such that an unambiguous angle measurement is possible. The aperture is significantly smaller than in the receiver array 44, however, so that the angular resolution is lower.

The equidistant arrangement of the antenna elements (in azimuth and in elevation) facilitates the evaluation of the data, because it, for instance, enables the use of a fast Fourier transformation (FFT) to calculate a two-dimensional angular spectrum.

In the evaluation stage 32, a two-dimensional spectrum in the dimensions distance and relative velocity is first calculated in a conventional manner using a Fourier transformation. This spectrum can then be used to identify individual objects and determine their distances and relative velocities. In the case of a single target scenario, i.e., if there is only a single object in each distance/velocity cell, the conventional MIMO model, which is briefly outlined below, can be used for the angle estimation in azimuth and elevation for each object. For the sake of simplicity, only the angle estimation in azimuth is considered, in which only the first row of the transmitting antennas 14 in the transmitter array 34 and only the first row of the receiving antennas 26 in the receiver array 36 have to be used.

xn denotes the four-component vector, the components (xn, 1, xn, 2, xn, 3, xn, 4) of which specify the complex amplitudes of the signals that are transmitted by the nth transmitting antenna 14 and received by the four receiving antennas 26. If d is the distance from antenna element to antenna element, 1 is the wavelength of the radar radiation, and s=xn, 1 is the complex amplitude of the signal that is received by the first receiving antenna (for example the rightmost receiving antenna of FIG. 2), due to the run length differences between the signals that reach the different receiving antennas 14, the following relationship applies:

xn(q)=s(1, e^{-2pi(d/1)sin(q)}, e−^{2pi(2d/1)sin(q)}, e−^{2pi(3d/1)sin(q)})^{T}=s [symbol] (q)

The superscript symbol “T” is intended to denote the transposition, because vectors are written here as row vectors but should be considered as column vectors. The vector aᵣₓ is referred to as the receive control vector. This control vector specifies the geometric properties and wave propagation properties of the receiver array.

A control vector [symbol] , which specifies the run length differences of the optical paths from the transmitting antennas to the object 24, can similarly be defined for the transmitter array 34 as well.

For the entire MIMO antenna array, the following control vector is obtained:

a(q)= [symbol] (q)* [symbol] (q)

The symbol * refers here to the Kronecker product.

The received signals form a vector x with Ntx. Nrx components (96 components in this example, because the number Ntx of the transmitting antennas is 8 and the number Nrx of the receiving antennas is 12), and the following applies:

x(q)=s a(q)

Knowing the control vector a(q) makes it possible to establish a (under suitable conditions unambiguous) relationship between the angle q of the object and the received signals x and deduce the azimuth angle q of the object from the amplitude and phase relationships of the received signals. However, since the receiving signals are more or less noisy in practice, the azimuth angle cannot be calculated exactly but can only be estimated, for example using a deterministic maximum likelihood estimation.

If this principle is generalized to multitarget estimations, the single angle q becomes a vector q, the components of which specify the angles of the different targets, the control vector a becomes a control matrix A, and the following relationship applies:

x=A q

Thus, in the case of two targets with the location angles q₁ and q₂:

x=[ [symbol] (q₁)* [symbol] (q₁) [symbol] (q₂)* [symbol] (q₂)]

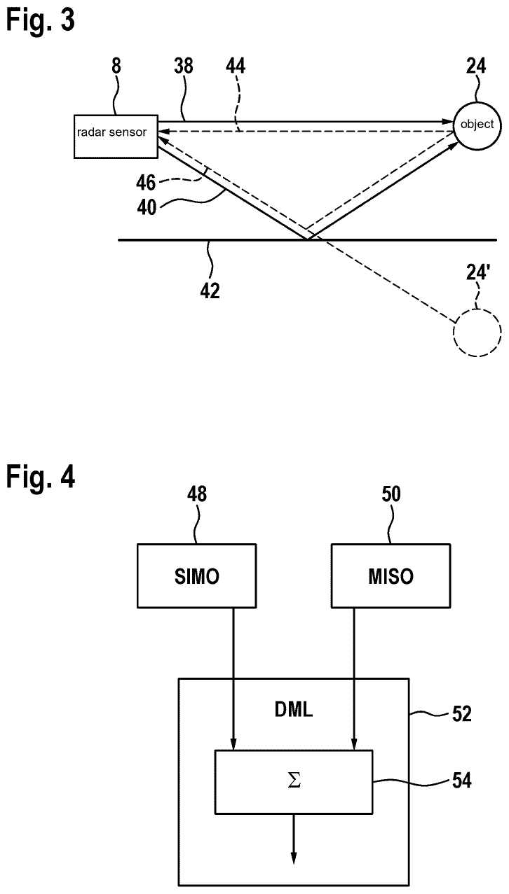

FIG. 3 outlines a scenario characterized by multipath propagation. The signal transmitted by the radar sensor 8 can propagate to the object 24 not only on a direct path 38 but also on an indirect path 40, which first leads to a reflecting surface 42, for example a guard rail, and is then deflected to the object 24. The signal 44 reflected on the object 24 can likewise propagate to the radar sensor 8 not only on a direct path 44 but also on an indirect path 46, on which the signal is again reflected on the surface 42 so that the radar sensor perceives what is actually a mirror object 24′.

In the case of multipath propagation, the complete MIMO signal model is a cross-path model, which has the following form:

x=[ [symbol] (q₁)* [symbol] (q₁) [symbol] (q₂)* [symbol] (q₂) [symbol] (q₂)* [symbol] (q₁) [symbol] (q₁)* [symbol] (q₂)]

Although the reciprocity of the cross-paths, i.e. the path combinations 38, 46 and 40, 44, allows the last two terms can be combined into a single path, the computational effort required to calculate the signal vector x is still greater than in the case of single path propagation.

However, this effort can be reduced by applying a method shown in FIG. 4 as a flow chart. In a SIMO mode 48, only signals transmitted by a single one of the transmitting antennas 14 and received by the multiple receiving antennas 26 are evaluated. At the same time, in a MISO mode 50, only signals transmitted by the multiple transmitting antennas 14 and received by a single receiving antenna 26 are evaluated. In the case of frequency- or code-division multiplexing, the frequencies or the coding of the signals can be used to distinguish which signal comes from which transmitting antenna. In the case of time-division multiplexing, multiplexing can be suspended in SIMO mode 48, which also results in a desired shortening of the measurement cycle.

For SIMO, the above-described cross-path model for all four paths reduces to:

x=[ [symbol] (q₁)* [symbol] (q₂)]

### and for MISO to:

x=[ [symbol] (q₁)* [symbol] (q₂)]

This results in a significant reduction in model complexity and computational load.

In a DML estimation stage 52, a spectrum is formed from the complex amplitudes obtained in SIMO mode and in MISO mode by calculating a DML estimation function q² (θ₁,θ₂) for each combination of location angles 0₁, 0₂. A sum spectrum 54 is then formed from these spectra and a global maximum is sought in that sum spectrum for each target.

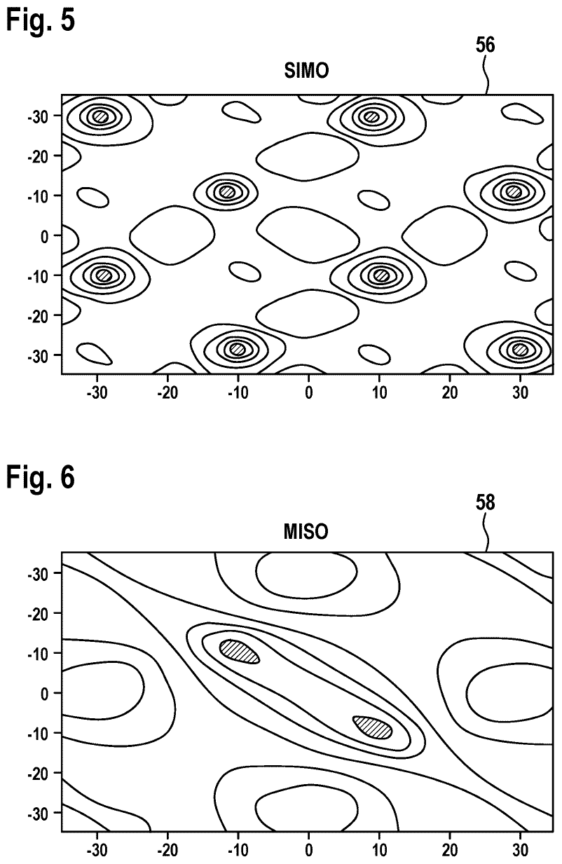

As an example, FIG. 5 shows the DML estimation function q² (θ₁, θ₂) for a spectrum 56 obtained in SIMO mode 48. The functional values are indicated by contour lines for equal values of q².

Local maximums of the function are depicted with cross-hatching. The initial scenario (ground truth) is given by here by θ₁=10°, θ₂=10° and an equal amplitude of the four paths. The distances between the four receiving channels are [0, 1.5, 3, 4.5]λ, the distances between the three transmission channels are [0, 1, 2] λ.

For the same scenario, FIG. 6 shows the DML estimation function q² (θ₁,θ₂) for the spectrum 58 obtained in MISO mode 50.

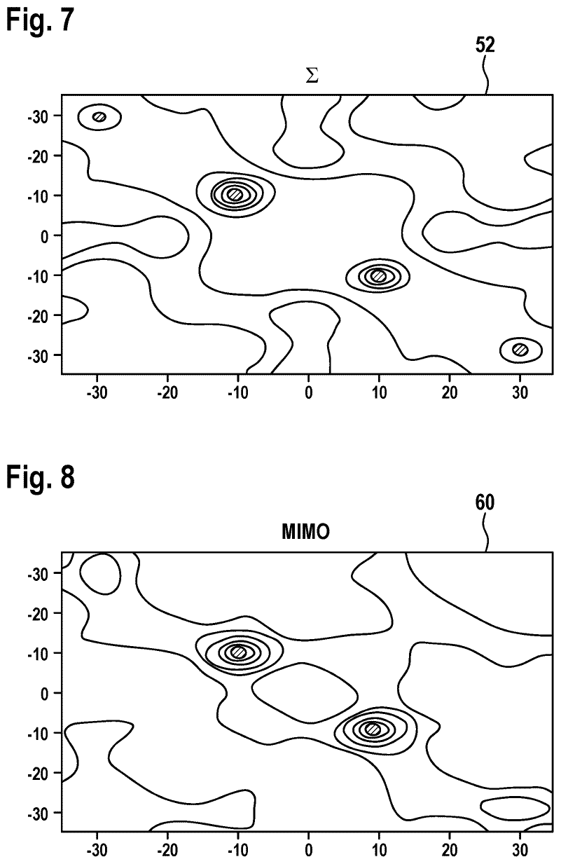

FIG. 7 shows the estimation function for the associated sum spectrum 52.

It can clearly be seen that the SIMO spectrum 48 is ambiguous; there are several maximums that have the same height as the global maximum. The MISO spectrum 50, on the other hand, only allows the angle to be determined with very low precision, because, due to the very small MISO aperture, the line of the global maximum is very broad. In contrast, the sum spectrum 52 allows unambiguous and precise angle determination.

For comparison, FIG. 8 shows a spectrum 60 that is based on the complete cross-path model for MIMO and the calculation of which requires a significantly more effort. It can be seen that the significance of the much easier to calculate spectrum 52 is very close to the significance of the complete model (spectrum 60).

1-7. (canceled)

8. A method for angle estimation using signals, from an in at least one dimension angle-resolving and MIMO-capable antenna array including a radar sensor, that are transmitted and received after being reflected on an object, the method comprising:
estimating, using a cross-path model which also models reflections of transmitted and/or received signals from a reflecting surface, a location angle of a radar target, wherein the location angle estimation is based on a reduced cross-path model that combines a model for a SIMO mode of the radar sensor with a model for a MISO mode.

9. The method according to claim 8, wherein two separate DML estimation functions are calculated for a spectrum obtained in the SIMO mode and a spectrum obtained in the MISO mode, and then a sum spectrum is formed by arithmetically averaging the two DML estimation functions, and a global maximum of the sum spectrum is sought.

10. A radar sensor, comprising:
a transmitting and receiving device with a MIMO-capable antenna array; and
a digital evaluation stage configured for angle estimation using signals, from an in at least one dimension angle-resolving and the MIMO-capable antenna array including a radar sensor, that are transmitted and received after being reflected on an object, the digital evaluation state configured to:
estimate, using a cross-path model which also models reflections of transmitted and/or received signals from a reflecting surface, a location angle of a radar target, wherein the location angle estimation is based on a reduced cross-path model that combines a model for a SIMO mode of the radar sensor with a model for a MISO mode.

11. The radar sensor according to claim 10, further comprising a transmitter array and a receiver array, wherein a first of the transmitter and receiver arrays is configured for an unambiguous angle measurement and an other array of the transmitter and receiver arrays is configured for an ambiguous angle measurement and has a larger aperture than the first.

12. The radar sensor according to claim 11, wherein all transmitting antennas of the transmitter array are spaced at equal intervals in at least one dimension.

13. The radar sensor according to claim 11, wherein all receiving antennas of the receiver array are spaced at equal intervals in at least one dimension.

14. The radar sensor according to claim 11, wherein at least one of the transmitter and receiver arrays is a two-dimensional array.
